(19) United States
(12) Patent Application Publication
(10) Pub. No.: US 2026/0280875 A1
(43) Pub. Date: Sep. 17, 2026

(54) WIRELESS INTERFERENCE-FREE SECURE RECEIVE-ONLY DISCRETE CONTROL SOFTWARE

(71) Applicant: Hamilton Sundstrand Corporation, Charlotte, NC (US)

(72) Inventors: Manu Bittugondanahalli Indrakumar, Bengaluru (IN); Balaji Krishnakumar, Bengaluru (IN); Vaishnavi Sunil Kulkarni, Bengaluru (IN); Neha Krishna Chittappa, Bengaluru (IN); Faizanbaig Inamdar, Belgaum (IN); Karthik Rao Guddekoppa Ganesh, Mysore (IN)

(21) Appl. No.: 19/446,755

(22) Filed: Jan. 12, 2026

(30) Foreign Application Priority Data
Mar. 12, 2025 (IN) 202541022373

(51) Int. Cl. H04L 9/32

(52) U.S. Cl. CPC H04L 9/32

(57) ABSTRACT

A method includes determining whether an aircraft is connected to an external power source and, if so, switching a wireless interface of the aircraft to a receive-only mode. The method also includes receiving, via the wireless interface at different times, beacon packets each containing encrypted authentication information. The method further includes performing a first authentication based on the encrypted authentication information and, responsive to performing the first authentication successfully, switching a test interface of flight control software of the aircraft to an enabled mode and performing a second authentication between the test interface and a source of the beacon packets. In addition, the method includes, responsive to performing the second authentication successfully, establishing a secure two-way wireless communication connection between the test interface and the source of the beacon packets and transmitting, via the secure two-way wireless communication connection, response packets from the test interface.

### CROSS-REFERENCE TO RELATED APPLICATION AND PRIORITY CLAIM

This application claims priority under 35 U.S.C. § 119 to Indian Provisional Patent Application No. 202541022373 filed on March 12, 2025, which is hereby incorporated by reference in its entirety.

### TECHNICAL FIELD

This disclosure relates generally to networking for on-the-ground aircraft diagnostics. More specifically, this disclosure relates to wireless interference-free secure receive-only discrete control software.

### BACKGROUND

Computer systems and software for aircraft applications present unique networking challenges. For practical and regulatory reasons (such as DO-178C certification), they are designed to be hardened against interference from actors attempting to wirelessly connect to aircraft systems and software using common wireless protocols (such as Wi-Fi, Bluetooth, and other common wireless networking protocols) and also from interference from other aircraft systems. At the same time, line replaceable units (LRUs) and other aircraft computing systems executing flight control software are expected to provide test interfaces through which, in addition to “normal” aircraft in-flight operation of the software, they provide test interface functionality in a test mode through the test interfaces.

### SUMMARY

This disclosure provides for wireless, interference-free, secure receive-only discrete control software.

In some examples, a method includes determining whether an aircraft is connected to an external power source, where flight control software of the aircraft is configured to provide a test interface. The method also includes, responsive to determining that the aircraft is connected to the external power source, switching a wireless interface of the aircraft to a receive-only mode. The method further includes receiving, via the wireless interface at a first time, a first beacon packet containing first encrypted authentication information and receiving, via the wireless interface at a second time, a second beacon packet containing second encrypted authentication information. The method also includes performing a first authentication based on the first and second encrypted authentication information and arrival of the second beacon packet in a predetermined time window. The method further includes, responsive to performing the first authentication successfully, switching the test interface to an enabled mode and performing a second authentication between the test interface and a source of the first and second beacon packets. In addition, the method includes, responsive to performing the second authentication successfully, establishing a secure two-way wireless communication connection between the test interface and the source of the first and second beacon packets and transmitting, via the secure two-way wireless communication connection, first response packets from the test interface.

In other examples, an apparatus includes a wireless interface and at least one processing device. The at least one processing device is configured to determine whether an aircraft is connected to an external power source and, responsive to determining that the aircraft is connected to the external power source, switch the wireless interface to a receive-only mode. The at least one processing device is also configured to receive, via the wireless interface at a first time, a first beacon packet containing first encrypted authentication information and receive, via the wireless interface at a second time, a second beacon packet containing second encrypted authentication information. The at least one processing device is further configured to perform a first authentication based on the first and second encrypted authentication information and arrival of the second beacon packet in a predetermined time window. The at least one processing device is also configured, responsive to performing the first authentication successfully, to switch a test interface of flight control software of the aircraft to an enabled mode and perform a second authentication between the test interface and a source of the first and second beacon packets. In addition, the at least one processing device is configured, responsive to performing the second authentication successfully, to establish a secure two-way wireless communication connection between the test interface and the source of the first and second beacon packets and transmit, via the secure two-way wireless communication connection, first response packets from the test interface.

In still other examples, a non-transitory machine-readable medium contains instructions that when executed cause at least one processor to determine whether an aircraft is connected to an external power source. The non-transitory machine-readable medium also contains instructions that when executed cause the at least one processor, responsive to determining that the aircraft is connected to the external power source, to switch a wireless interface to a receive-only mode. The non-transitory machine-readable medium further contains instructions that when executed cause the at least one processor to receive, via the wireless interface at a first time, a first beacon packet containing first encrypted authentication information and receive, via the wireless interface at a second time, a second beacon packet containing second encrypted authentication information. The non-transitory machine-readable medium also contains instructions that when executed cause the at least one processor to perform a first authentication based on the first and second encrypted authentication information and arrival of the second beacon packet in a predetermined time window. The non-transitory machine-readable medium further contains instructions that when executed cause the at least one processor, responsive to performing the first authentication successfully, to switch a test interface of flight control software of the aircraft to an enabled mode and perform a second authentication between the test interface and a source of the first and second beacon packets. In addition, the non-transitory machine-readable medium contains instructions that when executed cause the at least one processor, responsive to performing the second authentication successfully, to establish a secure two-way wireless communication connection between the test interface and the source of the first and second beacon packets and transmit, via the secure two-way wireless communication connection, first response packets from the test interface.

Any single one or any combination of the following features may be used with the examples above. The first encrypted authentication information may include an integrity check value (ICV) and data encrypted with a pre-shared symmetric key. The data encrypted with the pre-shared symmetric key may include at least one of: a unique identifier, a sequence number of the first beacon packet, and a timeout timer value. The predetermined time window may include a tolerance window subsequent to a timeout window, and the timeout window may have a length based on the timeout timer value. The second authentication may include at least one of: an authentication according to a Wi-Fi Protected Access (WPA) protocol and an authentication according to a Datagram Transport Layer Security (DTLS) protocol. An avionics line replaceable unit (LRU) may be used to perform the method, may be represented by the apparatus, or may execute the instructions. Prior to sending second response packets from the test interface, a determination may be made whether the aircraft is still connected to the external power source, a determination may be made whether the test interface is in the enabled mode, and/or a determination may be made whether the secure two-way wireless communication connection between the test interface and the source of the first and second beacon packets has timed out.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example device for performing operations according to this disclosure;

FIG. 2 illustrates an example system for implementing a wireless interference-free secure receive-only discrete control software (SRDCS) computer program product according to this disclosure;

FIG. 3 illustrates an example signal flow of an SRDCS for authenticating beacon packets received from a test computer and establishing secure wireless communication between a test interface and the test computer according to this disclosure;

FIG. 4 illustrates an example frame structure of one or more beacon packets according to this disclosure;

FIGS. 5A through 5F illustrate operations of an example method for securely authenticating a test computer and wirelessly connecting the test computer to a test interface according to this disclosure; and

FIG. 6 illustrates operations of an example method for secure interference-free enablement of a discrete control of a test interface and bidirectional communication between the test interface and a test computer according to this disclosure.

### DETAILED DESCRIPTION

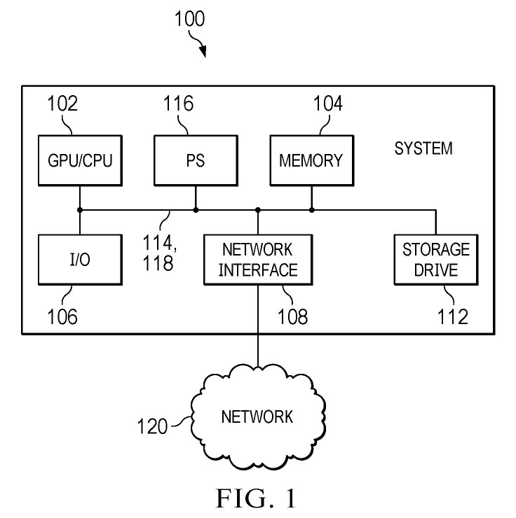

FIGS. 1 through 6, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As noted above, computer systems and software for aircraft applications present unique networking challenges. For practical and regulatory reasons (such as DO-178C certification), they are designed to be hardened against interference from actors attempting to wirelessly connect to aircraft systems and software using common wireless protocols (such as Wi-Fi, Bluetooth, and other common wireless networking protocols) as well as from interference from other aircraft systems. At the same time, line replaceable units (LRUs) and other aircraft computing systems executing flight control software are expected to provide test interfaces through which, in addition to “normal” aircraft in-flight operation of the software, they provide test interface functionality in a test mode through the test interfaces.

To reconcile the competing needs for (i) providing test interfaces and test modes for LRUs and other systems and (ii) ensuring that such systems remain in “normal” flight mode during flight so that the test interfaces cannot be enabled by requests from unfamiliar devices on wireless networks, activation of the test interfaces has historically only been possible via physical network connections, such as Ethernet connections. However, requiring physical wired connections to activate test interfaces can limit the opportunities to interrogate and update LRUs and other systems to factory maintenance and developmental testing operations, excluding other contexts where activating the test interfaces over Ethernet connections may be desirable, but not possible. Expanding the range of operating contexts under which a test interface can be activated and wirelessly communicate with an LRU or other onboard aircraft system, while at the same time not interfering with other wireless systems on an aircraft, presents technical challenges and opportunities for improvement.

Various embodiments of this disclosure provide a wireless interference-free secure receive-only interface mechanism that can wirelessly activate a test interface of flight control software, such as through secure interference-free authentication. In embodiments according to this disclosure, secure interference-free activation of the test interface can be limited to occur only when the aircraft containing an LRU or other tested system is on the ground and connected to external power, where a secure sequence of time-controlled commands from a maintenance computer have been received. Also, in embodiments according to this disclosure, the LRU or other tested system is kept in a receive-only mode during the testing interface activation, thereby precluding wireless transmissions from the LRU or other tested system from interfering with other wireless signaling within the aircraft.

Once a wireless link between the test interface and the LRU or other tested system is enabled, the test interface may optionally employ a two-or-more-layered security configuration in some embodiments. For example, a first layer of security may be provided on the media access control (MAC) layer, such as by using Wi-Fi Protected Access (WPA). A second layer of security may be provided on the transport layer, such as by using Datagram Transport Layer Security (DTLS). If any authentication failure or message timeout occurs, the wireless connection to the test interface can be disabled.

In this way, embodiments according to this disclosure provide enhanced functionality of wireless activation of a wireless connection between a test interface and an LRU or other aircraft system whose connectivity is governed by one or more hard constraints (such as DO-178 certification requirements).

FIG. 1 illustrates an example device 100 for performing operations according to this disclosure. In some embodiments, the device 100 can represent a test computer or other component that acts as a wireless access point for activating a wireless link between a test interface and an LRU, other aircraft component, or other device executing secure receive-only discrete control software. In this example, the device 100 can include a controller (such as a processor, central processing unit (“CPU”), and/or graphics processing unit (“GPU”)) 102, a memory unit 104, and an input/output (“I/O”) device 106. The device 100 also includes at least one network interface 108, such as a network interface controller (NIC), that can facilitate communications over a communication medium. The device 100 further includes a storage drive 112 used for storing content, such as software resources and other data. The components 102, 104, 106, 108, and 112 are interconnected by a data transport system (such as a bus) 114. A power supply unit (PSU) 116 provides power to components of the device 100, such as via a power transport system 118 (which is shown with the data transport system 114 in this example but may be separate). Various connections can be wired or wireless.

It will be understood that the device 100 may be configured differently and that each of the identified components may actually represent several different components. For example, the controller 102 may actually represent a multi-processor system or a distributed processing system; the memory unit 104 may include different levels of cache memory and main memory; the I/O device 106 may include one or more monitors, keyboards, touchscreens, and the like; the at least one network interface 108 may include one or more network cards providing one or more wired and/or wireless connections to a network 120; and the storage drive 112 may include one or more hard disks, random access memory, read-only memory, remote storage locations, or other storage devices. Therefore, a wide range of flexibility is anticipated in the configuration of the device 100, which may range from a single physical platform configured primarily for a single user or autonomous operation to a distributed multi-user platform, such as a cloud computing system.

The device 100 may use any suitable operating system (or multiple operating systems), including various versions of WINDOWS, MAC OS, UNIX, RTOS, and LINUX. The device 100 may include one or more operating systems specific to aerospace applications, such as VXWORX or LYNXOS, personal computers, servers, or other computing platforms depending on the use of the device 100. The operating system, as well as other instructions, may be stored in the memory unit 104 and executed by the controller 102. The memory unit 104 may include instructions for performing some or all of the steps, process, and methods described below, such as instructions for implementing a test interface and obtaining diagnostic data of the aircraft.

The network 120 may be a single network or may represent multiple networks, including networks of different types, whether wireless or wired. For example, the device 100 may be coupled to external devices via a network that includes a cellular link coupled to a data packet network or may be coupled via a data packet link, such as a wide local area network (WLAN) coupled to a data packet network or a Public Switched Telephone Network (PSTN). Accordingly, many different network types can be present within the environment in which the device 100 operates and manages the connectivity between a test interface and an LRU or other component executing flight control software for an aircraft under conditions that ensure the test interface is not wirelessly connected to the LRU or other aircraft systems at times when flight control software is executing normally.

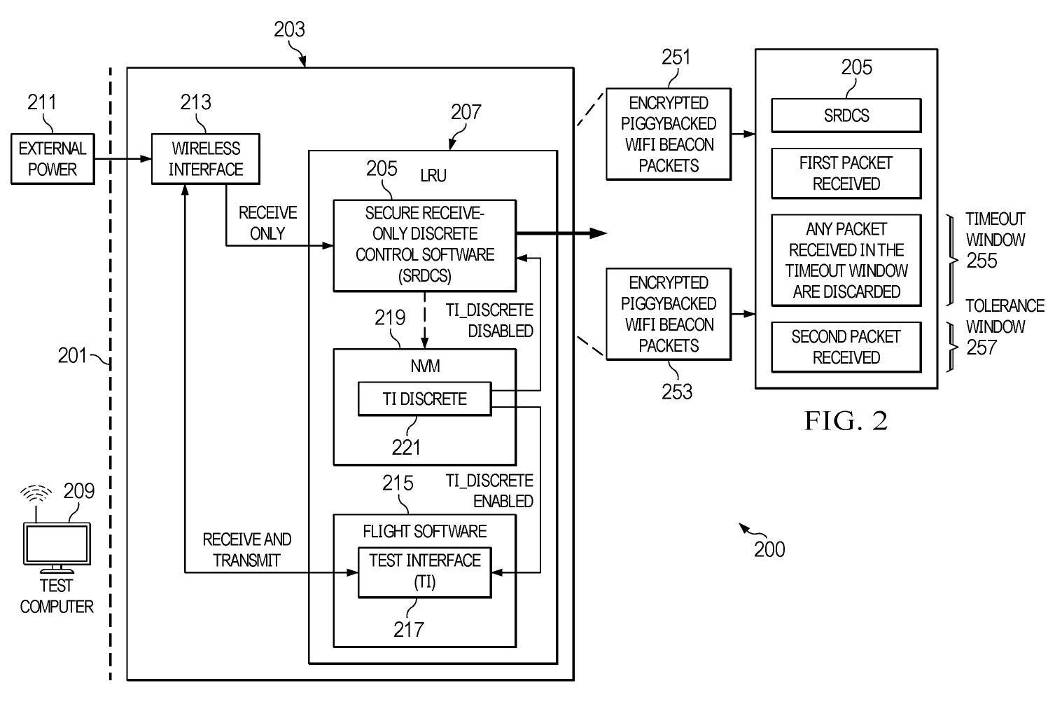

FIG. 2 illustrates an example system 200 for implementing a wireless interference-free secure receive-only discrete control software (SRDCS) computer program product according to this disclosure. As shown in FIG. 2, elements residing on an aircraft or executing on one or more processing devices of the aircraft are shown on the right side of line 201. Systems resident on or executing on systems outside of the aircraft are shown on the left side of the line 201. Additionally, an SRDCS 205 is intentionally shown twice in FIG. 2, both as a component of an on-aircraft system 203 and in expanded detail on the right-hand side of FIG. 2.

As noted elsewhere in this disclosure, policing the connectivity of wireless communication networks within an aircraft and controlling activation of one or more test interfaces for flight control software presents technical challenges. In some embodiments, a test computer 209 outside of the aircraft can operate as a wireless access point (AP) to which an aircraft LRU 207 can connect, provided certain initial and ongoing security criteria described here are satisfied. In this example, the SRDCS 205 operates as a manager/screener that, when the aircraft is connected to an external power source 211, examines tests packets received via the aircraft’s wireless interface 213. The wireless interface 213 is connected to the LRU 207. In a secure authenticated test mode, the test interface 217 of the flight software 215 can communicate with the test computer 209 via the wireless interface 213. The SRDCS 205 regulates the operation of a network visibility module (NVM) 219, which implements a discrete control 221 for enabling the test interface 217.

The NVM 219 and the discrete control 221 are configured such that the default setting for the test interface 217 is a deactivated state, where the test interface 217 is not activated and cannot wirelessly connect to other systems via the wireless interface 213. To activate the test interface 217 and establish two-way (receive and transmit) communication between the test interface 217 and the test computer 209, the SRDCS 205 needs to successfully progress from an initial deactivated phase to an SRDCS phase and finally to a test interface phase.

Responsive to the system 203 connecting to and being powered by the external power source 211, the SRDCS 205 can switch from its deactivated phase to the SRDCS phase. During the SRDCS phase, the SRDCS 205 operates in a receive-only mode, listening for encrypted packets satisfying criteria for authenticity received via the wireless interface 213. Connection to the external power source 211 can be a reliable proxy for the aircraft not being in flight and thus being in an operating state where wireless signals received from the test interface 217 and transmitted by the wireless interface 213 cannot interfere with systems controlling the aircraft’s flight (because the aircraft is connected to an external power source and thus not in flight). Further, until the source of external packets received via the wireless interface 213 can be confirmed as trustworthy (such as coming from an authorized computer system of an airline as opposed to a bad actor spoofing previously-intercepted packets sent by an authorized computer), the SRDCS 205 is configured during the SRDCS phase to connect the LRU 207 to the test computer 209 in a receive-only mode.

Upon authentication of the received packets as coming from a trusted source (such as the test computer 209), the SRDCS 205 transitions to the test interface phase. In the test interface phase, an encrypted bidirectional wireless communication session is established between the test interface 217 and the test computer 209. In the test interface phase, the SRDCS 205 becomes inactive, unless one or more of the wireless connection between the test interface 217 and the test computer 209 or the connection to the external power source 211 is lost, in which case the SRDCS 205 defaults back to one of the deactivated phase or the SRDCS phase.

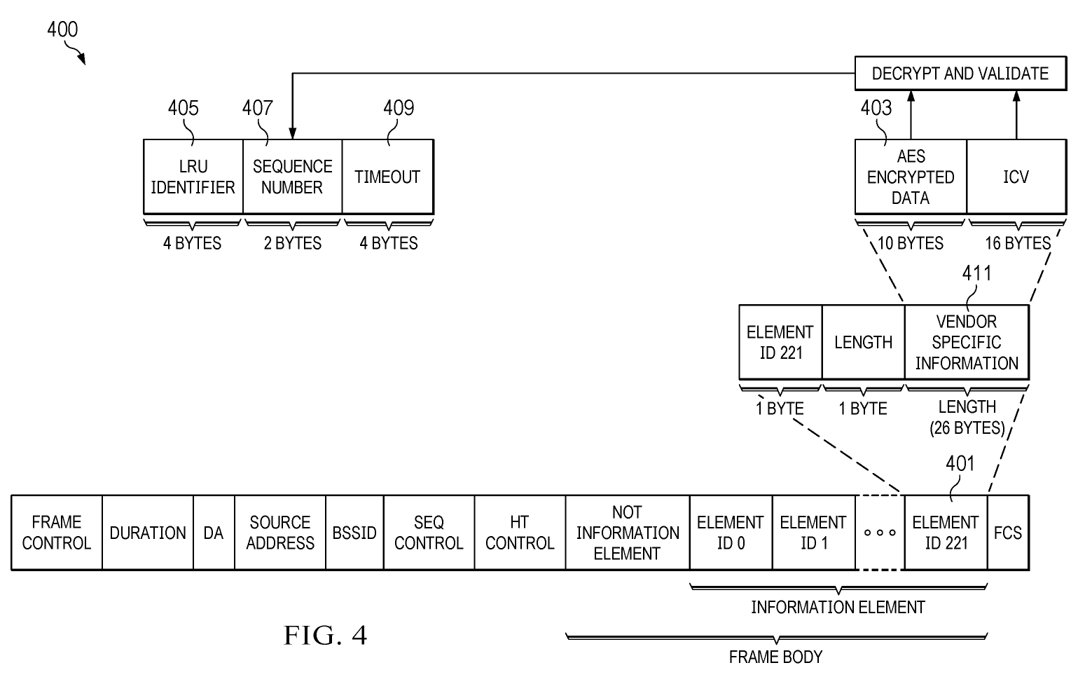

During the SRDCS phase, beacon packets (such as a first beacon packet 251 and a second beacon packet 253) are received via the wireless interface 213. As described in greater detail below with reference to FIG. 4, the beacon packets can be encrypted Wi-Fi packets containing authentication information (such as an encrypted value of a unique device-specific identifier of an LRU, such as LRU 207) with which the test computer 209 sending the beacon packets seeks to wirelessly connect. The beacon packets 251 and 253 are decrypted and examined by the SRDCS 205 to test for one or more criteria. Example criteria may include determining whether the packets contain the correct device-specific identifier, determining if the packets are received at a proper time interval (such as whether the second beacon packet 253 is received outside of a timeout window 255 and within a tolerance window 257), and determining whether the packets contain correct sequencing metadata (such as whether a sequence number of the second beacon packet 253 is correctly incremented from a sequence number of the first beacon packet 251). In this way, even if a malicious actor intercepts and rebroadcasts previously-transmitted beacon packets for connecting to another aircraft, the three layers of authentication performed by the SRDCS 205 can detect one or more of an incorrect aircraft identifier, incorrect timing, or incorrect sequencing metadata. Upon receiving two or more beacon packets containing a correct device-specific identifier, satisfying the timing requirements, and containing the correct sequencing information, the SRDCS 205 can switch from the SRDCS phase to the test interface phase.

Note that FIG. 2 is intended to be illustrative of, rather than limitative of, embodiments according to this disclosure. In some embodiments, instead of the at least one on-aircraft processor being part of an LRU, it could be part of a different networked processing system of the aircraft, such as a fully autonomous digital engine control (“FADEC”).

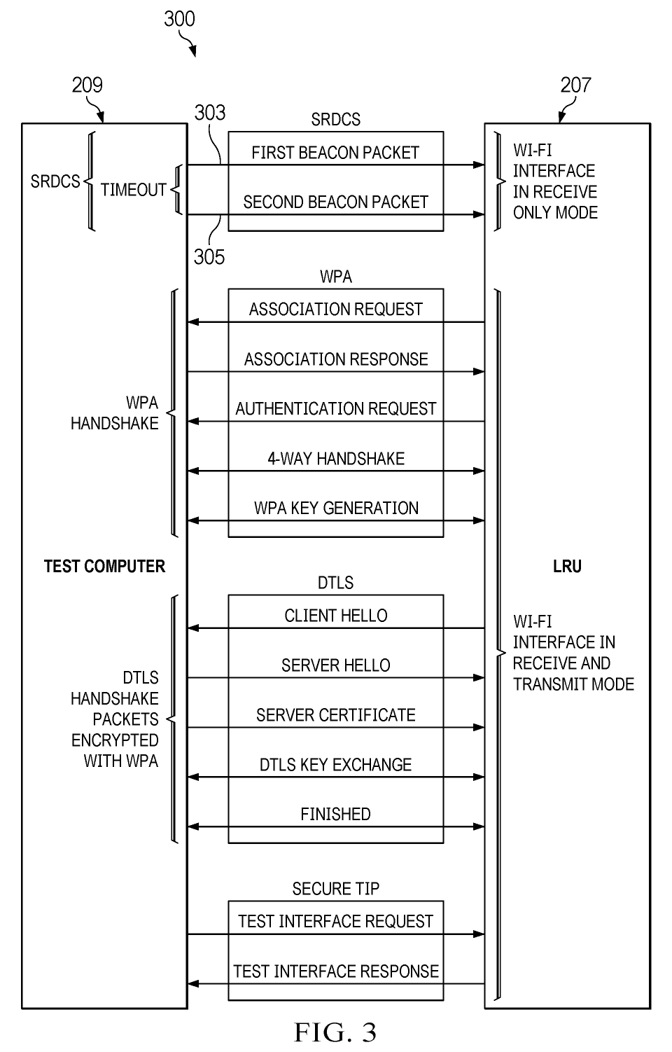

FIG. 3 illustrates an example signal flow 300 of an SRDCS 205 for authenticating beacon packets received from a test computer 209 and establishing secure wireless communication between a test interface 217 and the test computer 209 according to this disclosure. FIG. 4 illustrates an example frame structure 400 of one or more beacon packets 251, 253 according to this disclosure. For consistency and convenience of cross-reference, elements of FIGS. 3 and 4 introduced in FIG. 2 are numbered similarly.

As shown in FIG. 3, the signal flow 300 begins after the system executing the software with the test interface 217 (such as the LRU 207) has detected a connection to an external power source (such as the external power source 211) and the SRDCS 205 has gone from a deactivated phase to a SRDCS phase, during which a Wi-Fi interface (or other wireless interface of the aircraft) is at least initially operating in a receive-only mode. In this example, the test computer 209 is a legitimate actor that seeks to wirelessly connect with one or more test interfaces 217 operating on the aircraft, where the SRDCS 205 is configured to both activate the test interface 217 (such as via the discrete control 221 in FIG. 2) and enable two-way wireless communication between the LRU 207 and the test computer 209. To initiate the authentication and connection process, the test computer 209 periodically sends beacon packets, including first and second beacon packets 303 and 305, which in some cases may include Wi-Fi 802.11n beacon packets.

As shown in FIG. 4, the packet frame structure 400 can include an information element 401 containing access point (AP) beacon information, as well as encrypted SRDCS information 403 embedded in the same beacon packet. The SRDCS information 403 can be encrypted. When decrypted, the SRDCS information 403 can include a four-byte or other LRU unique identifier 405, a two-byte or other sequence number 407, and a four-byte or other timeout value 409. The SRDCS information 403 can be encrypted by any suitable symmetric encryption algorithm, such as an Advanced Encryption Standard with Galois Counter Mode (AES-GCM) encryption. Both the test computer 209 and the SRDCS 205 can be keyed according to a common symmetric key. The encrypted data, along with a sixteen-byte or other Integrity Check Value (ICV) value, forms the SRDCS information 403, which in some cases can be embedded within a beacon packet as part of vendor-specific information 411.

Returning to FIG. 3, the first beacon packet 303 is wirelessly transmitted by the test computer 209, received at a wireless interface (such as wireless interface 213 in FIG. 2) of the aircraft, and passed to the SRDCS 205. Depending on the architecture of the system, the SRDCS 205 can be executing on the same processing device(s) (such as the LRU 207) as the flight control software providing the test interface 217. Alternatively, the SRDCS 205 can execute on a different processing device or devices.

The SRDCS 205 examines the first beacon packet 303 to determine if the first beacon packet 303 contains vendor-specific information (such as vendor-specific information 411 in FIG. 4). If so, the SRDCS 205 extracts the vendor-specific information and decrypts a predetermined portion of the vendor-specific information. In embodiments in which the first beacon packet 303 embodies the packet frame structure 400 shown in FIG. 4, the SRDCS 205 decrypts the first ten bytes of data, such as by using an AES-GCM pre-shared common symmetric key, and validates the decrypted data, such as by using the ICV embedded in the vendor-specific information.

If decryption and validation of the vendor-specific information of the first beacon packet 303 is successful, the SRDCS 205 can compare the first four bytes or other portion of the unique identifier with the LRU’s unique identifier (such as LRU unique identifier 405). If the validation matches, the SRDCS 205 treats the first beacon packet 303 as the first packet received successfully and stores the sequence number and timeout value present in vendor-specific data of the beacon packet. Additionally, the SRDCS 205 can start a timer keyed to the time that the first beacon packet 303 was received.

For a sequence of beacon packets to be authenticated by the SRDCS 205, the packets may need to arrive within a tolerance window and not during a timeout window prior to the tolerance window. Packets received within the timeout window period of the first beacon packet 303 can be discarded. Similarly, packets received after the timeout value and within the tolerance window of the first beacon packet 303 can be accepted by the SRDCS 205, which proceeds to decrypt the subsequently-received beacon packet(s). After decryption, the SRDCS 205 can check the validity of the of the subsequently-received beacon packet(s), such as by checking for a matching LRU unique identifier number and comparing the sequence number(s) of the subsequently-received packet(s) against a sequence number of the first beacon packet 303. If the sequence number of a subsequently-received beacon packet has a suitable value, such as a value incremented by one from the sequence number of the first beacon packet 303, the SRDCS 205 confirms the subsequently-received packet as a second beacon packet 305. As discussed with reference to FIG. 2, by confirming that a sequence of received beacon packets contains the correct device identifier information and that sequence number and conforms to the appropriate timing criteria, the SRDCS 205 authenticates the test computer 209 and instructs a discrete control (such as the discrete control 221) to activate the test interface 217 of the flight software.

Once the software test interface discrete control is enabled, the SRDCS 205 is disabled for as long as a secure wireless connection with the test computer 209 exists and the LRU 207 continues to operate under power provided by the external power source 211. Also, the aircraft’s wireless interface (such as the wireless interface 213 or a Wi-Fi interface) is configured to permit receive and transmit operations. Further, the LRU 207 establishes a secure communication channel with the test computer 209 using any suitable secure channel communication protocol(s), such as the Wi-Fi Protected Access (WPA) and Datagram Transport Layer Security (DTLS 1.3) authentication protocols.

Note that FIGS. 3 and 4 are illustrative of, rather than limitative of, embodiments of this disclosure, which contemplates embodiments different than those described in FIGS. 3 and 4. For example, in some embodiments, a different packet frame structure than shown in FIG. 4 can be used.

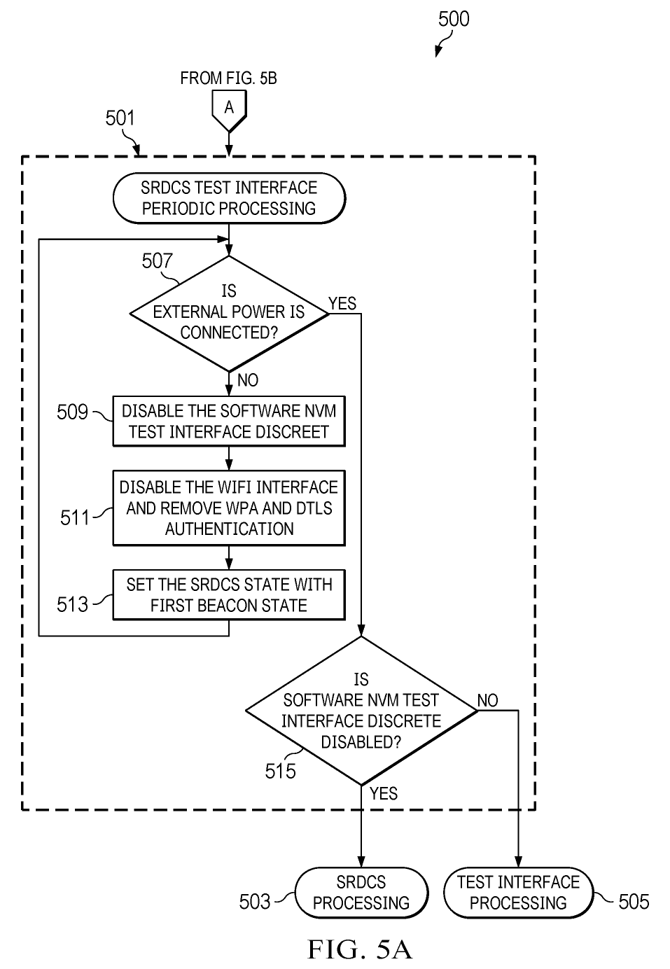

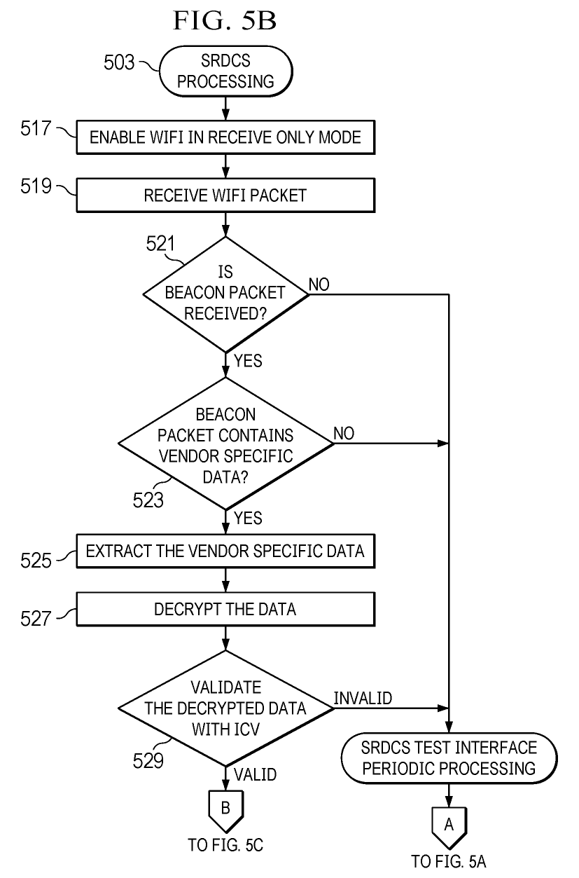

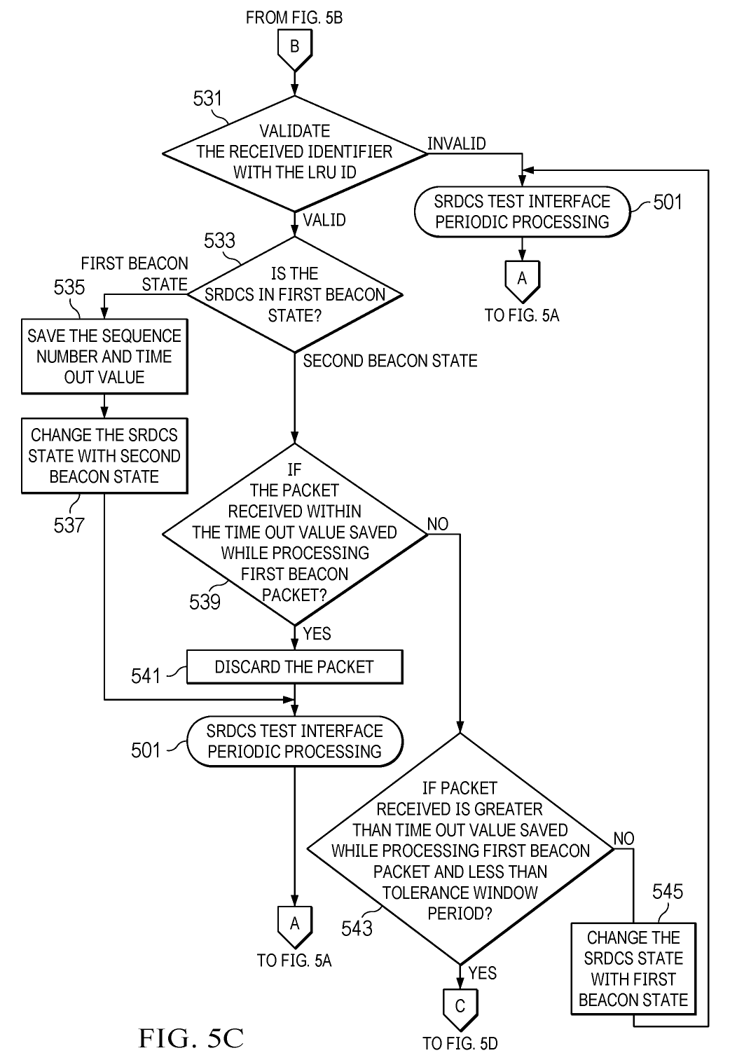

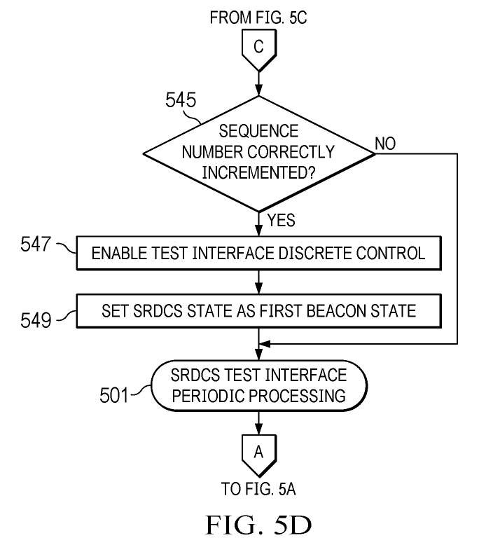

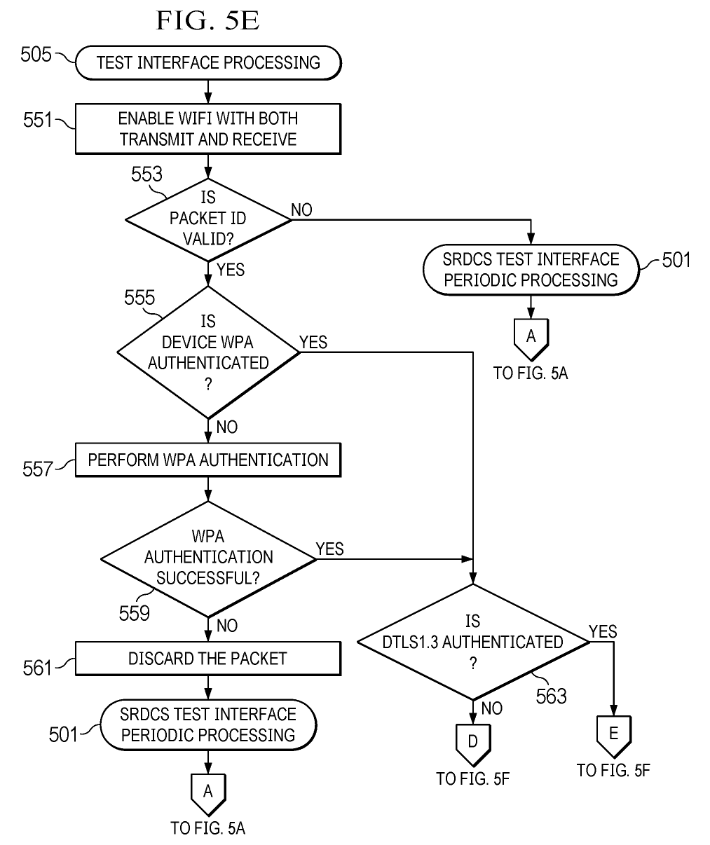

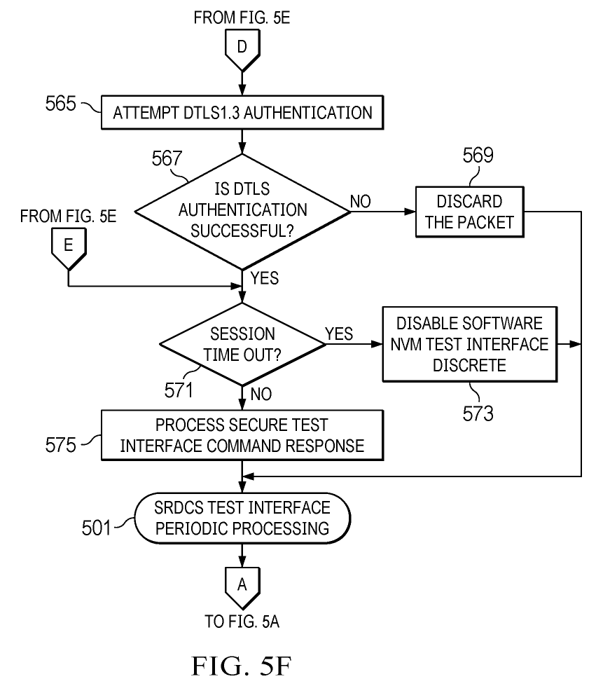

FIGS. 5A through 5F illustrate operations of an example method 500 for securely authenticating a test computer and wirelessly connecting the test computer to a test interface according to this disclosure. For consistency and convenience, elements shown in more than one of FIGS. 5A through 5F or described elsewhere in this disclosure are numbered similarly. In these figures, the method 500 includes a main control loop having three main handling routines: (1) SRDCS test interface periodic processing 501, (2) SRDCS processing 503, and (3) test interface processing 505. These main handling routines can correspond respectively to the deactivated phase, SRDCS phase, and test interface phase described with reference to FIG. 2.

As shown in FIG. 5A, the SRDCS test interface periodic processing 501 includes a default safety mode in which the LRU 207 or other device periodically performs a first gating check at operation 507 to determine if the LRU 207 or other device is connected to the external power source 211. A determination at operation 507 that external power is not connected means the aircraft may still require its flight software to be in normal operation, and its test interface 217 should not be enabled. At operation 509, the discrete control 221 disables the test interface 217, foreclosing any possibility of the test interface 217 causing interference with other aircraft subsystems. Additionally, if external power is not connected, at operation 511, any two-way operation of the wireless interface is disabled, and any stored WPA and DTLS authentication data is flushed from the LRU 207 or other device. At operation 513, the SRDCS state is set to a first beacon state, which is described in further detail in FIG. 5C.

A determination at operation 507 that external power is connected implies that the aircraft is on ground, and wireless signaling to and from the test interface 217 presents no risk of interference with in-flight systems. Responsive to such a determination, the method 500 proceeds to operation 515 and performs a determination as to whether the discrete control is enabled or disabled. Responsive to a determination at operation 515 that the discrete control is disabled, method 500 proceeds to the SRDCS processing 503 (described with reference to FIGS. 5B through 5D). As discussed elsewhere, to enable the test interface 217, embodiments according to this disclosure perform interference-free secure receive-only discrete control software authentication to confirm that a sequence of beacon packets from an on-ground source satisfies one or more authentication criteria. Responsive to determinations at operations 507 and 515 that the external power is connected and the discrete control is enabled, the method 500 proceeds to test interface processing 505 (described with reference to FIGS. 5E and 5F).

As shown in FIGS. 5B through 5D, following determinations that the aircraft is connected to external power and the test interface 217 is disabled, the method 500 proceeds to operation 517, where the SRDCS 205 sets the wireless interface into a receive-only mode. Switching the wireless interface to a receive-only mode eliminates any possibility of the LRU 207 or other systems performing wireless transmissions that could interfere with other aircraft subsystems during authentication with an external device. At operation 519, the SRDCS 205 is configured to start listening for and (if locally transmitted) receiving beacon packets. Responsive to receiving a packet (which may or may not represent a beacon packet from a system authorized to connect to the test interface 217) at operation 521, the SRDCS 205 determines whether the received packet is a beacon packet adhering to an expected packet structure (such as the packet frame structure 400 described with reference to FIG. 4).

Responsive to determining that the received packet is not a beacon packet, the method 500 reverts to the SRDCS test interface periodic processing 501. Responsive to determining that the received packet has the structure of a beacon packet, a further determination is made at operation 523 as to whether the beacon packet contains vendor-specific data (such as vendor-specific information 411 in FIG. 4). If not, the received packet is discarded, and the method 500 reverts to the SRDCS test interface periodic processing 501. Otherwise, the method 500 proceeds to operations 525 and 527, where the vendor-specific data is extracted and decrypted. At operation 529, the integrity level value of the vendor-specific data is assessed for validity. In a valid packet, the vendor-specific data can include expected quantities of encrypted data and ICV value data, such as ten bytes of encrypted data and sixteen bytes of an ICV value. If the vendor-specific data fails to include the expected indicia of authenticity at operation 529, the method 500 reverts to the SRDCS test interface periodic processing 501.

Responsive to a determination that the beacon packet has encrypted data and ICV value data in the lengths associated with authentic packets, the method 500 proceeds to operation 531 (shown in FIG. 5C). At operation 531, the SRDCS 205 performs a validation operation to determine whether the LRU identifier (such as the LRU unique identifier 405 in FIG. 4) in the decrypted packet matches the LRU identifier of the device executing the SRDCS 205. If the LRU identifier in the decrypted packet does not match the LRU identifier of the aircraft’s LRU 207, the method 500 reverts to the SRDCS test interface periodic processing 501.

If the LRU 207 identifier in the decrypted packet matches the LRU identifier of the device executing the SRDCS 205, the method 500 proceeds to operation 533, where the SRDCS 205 determines whether the SRDCS 205 is in a first beacon state. The first beacon state indicates that no beacon packet satisfying the authenticity criteria set forth in FIGS. 5A through 5C has been previously received within a suitable timeframe, so there is no present need to determine whether the received packet has arrived in a tolerance window or has a correct sequence number.

If the SRDCS 205 determines that the SRDCS 205 is in the first beacon state, the method 500 proceeds to operation 535, where a sequence number and timeout time value associated with the first beacon packet are saved. At operation 537, the SRDCS state is switched from a first beacon state to a second beacon state. The second beacon state encompasses a state of the SRDCS 205 in which a first beacon packet with correct contents has been received. In this state, the SRDCS 205 needs to receive a second beacon with similarly-correct content within the tolerance window and with the correct sequence number in order to enable the test interface 217 and set up a secure bidirectional wireless communication session between the test interface 217 and the test computer 209. Subsequent to setting the SRDCS state to the second beacon state, the method 500 reverts to the SRDCS test interface periodic processing 501.

If the SRDCS 205 determines that the SRDCS 205 is in the second beacon state at operation 533, a determination is performed at operation 539 as to whether the received packet was received within the timeout value window set at operation 535 for a previously-received packet. If the second beacon packet was received within the timeout window, the method 500 proceeds to operation 541, where the packet is discarded and operation reverts to the SRDCS test interface periodic processing 501.

If it is determined that the second beacon packet is received outside of the timeout value window, the method 500 proceeds to operation 543, where the SRDCS 205 determines whether the second packet has been received with the specified tolerance window. If the second beacon packet arrives outside of both the timeout window and the tolerance window, the state of the SRDCS is set back to the first beacon state at operation 545, and the method 500 reverts to the SRDCS test interface periodic processing 501.

If the second beacon packet arrives within the tolerance window, the method 500 proceeds to operation 545 (shown in FIG. 5D). At operation 545, a further check of the second beacon packet is performed to determine if the sequence number in the packet (such as the sequence number 407 in FIG. 4) has been properly incremented from the previously-received beacon packet. In some embodiments, proper incrementation is achieved when the second beacon packet has a sequence number that is one greater than the sequence number of the previously-received beacon packet (meaning the two sequence numbers are adjacent and sequential). If the sequence number of the second beacon packet is not correctly incremented from the first beacon packet, the packet is discarded, and the method 500 reverts to the SRDCS test interface periodic processing 501. If the second beacon packet is determined to be correctly incremented relative to the first beacon packet, the test interface discrete control is set to enabled at operation 547, the SRDCS state is set to the first beacon state at operation 549, and the method 500 reverts back to the SRDCS test interface periodic processing 501. Provided the aircraft remains connected to external power, the fact that the test interface discrete control has been enabled means that, at operation 515, the method 500 now proceeds to the test interface processing 505.

At operation 551, the wireless interface 213 is switched from only permitting reception of packets to enabling transmission and reception of packets. At operation 553, the test interface 217 begins the wireless authentication process by determining if the most-recently received packet is valid or invalid, such as if there is a cyclic redundancy code (CRC) mismatch. If the most-recently received packet is invalid, the method 500 reverts to the SRDCS test interface periodic processing 501. If the most-recently received packet is valid, the method 500 checks to see if WPA authentication has been performed and a WPA session has been generated at operation 555. If not, a WPA session key is generated at operation 557, such as by attempting a request/response sequence followed by a four-way handshake as specified by the IEEE standard 802.11. At operation 559, a determination is performed as to whether the attempted WPA authentication was successful. If the WPA authentication was not successful (such as if the test computer 209 and LRU 207 do not agree on a common pre-shared key), the test interface discrete control is disabled, the most-recently received packet is discarded at operation 561, and the method 500 reverts to the SRDCS test interface periodic processing 501.

Responsive to determining that WPA authentication has been successfully performed at operation 555 or 559, a second determination is performed as to whether DTLS authentication has been successfully performed at operation 563. If it is determined that DTLS authentication has been successfully performed, the method 500 proceeds to point “E” in FIG. 5F. Otherwise, the method 500 proceeds to point “D” in FIG. 5F.

As shown in FIG. 5F, at operation 565, one of the test interface 217 or LRU 207 attempts to perform DTLS authentication. At operation 567, a determination is performed as to whether DTLS authentication was successfully performed. If the attempted DTS authentication was not successful, the most-recently received packet is discarded at operation 569, and the method 500 reverts to the SRDCS test interface periodic processing 501. If the DTLS authentication is found to have been successful, a determination is performed at operation 571 as to whether one or both of the DTLS or WPA sessions have timed out. In the event of WPA/DTLS session timeout, the test interface discrete control is disabled at operation 573, and the method 500 reverts to the SRDCS test interface periodic processing 501. In the event of no session timeout, secure test interface command response packets (such as responses to inputs embedded in received packets) are processed at operation 575, and the method 500 reverts to the SRDCS test interface periodic processing 501.

As the example described with reference to FIGS. 5A through 5F illustrates, in some embodiments, the combined authentication and test enablement process can be configured to disable the test interface 217 and repeatedly revert to an initial foundational set of tests to confirm that one or more criteria for implementing a test interface 217 remain satisfied (for example, that the aircraft is still connected to external power) and confirming that a tested component is only speaking with an authorized device whose packets bear indicia of trustworthiness. In this way, embodiments according to this disclosure can provide wireless ground-based access to test interfaces 217 for flight software while, at the same time, providing a suitable degree of assurance that the test interfaces 217 cannot be enabled or transmit at times when flight control software is expected to operate according to its “normal” in-flight mode.

Note that the operations described with reference to FIGS. 5A through 5F are intended to be illustrative of, rather than limitative of, embodiments according to this disclosure. In some embodiments, instead of setting SRDCS test interface periodic processing 501 as the single primary reversion point for error conditions during operation, multiple reversion points could be set to provide flexibility and improve throughput.

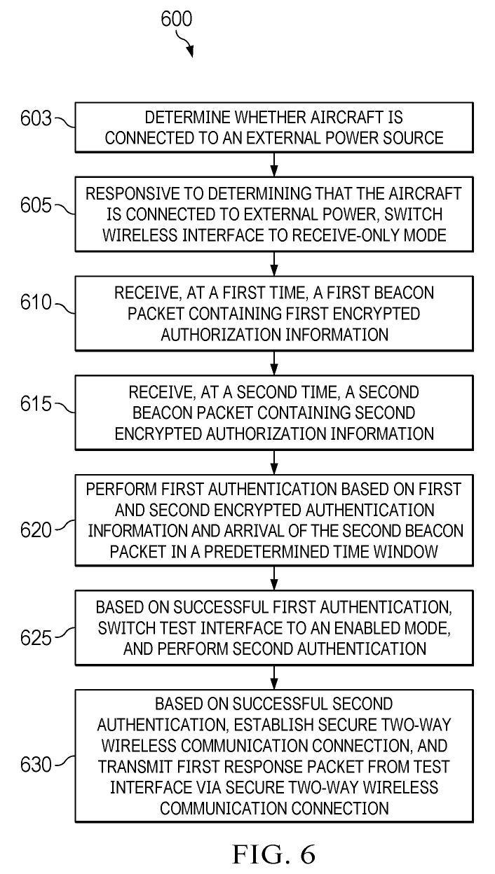

FIG. 6 illustrates operations of an example method 600 for secure interference-free enablement of a discrete control 221 of a test interface 217 and bidirectional communication between the test interface 217 and a test computer 209 according to this disclosure. The operations described with reference to FIG. 6 can be performed at any suitable combination of a ground-based processing device (such as the device 100 in FIG. 1 or the test computer 209 in FIG. 2) and an aircraft-based processing device (such as the device 100 in FIG. 1 or the LRU 207 in FIG. 2) already described or other equivalent aircraft processing devices (such as a FADEC) connected to a wireless interface.

As shown in FIG. 6, at operation 603, the aircraft-based processing device determines whether the aircraft is connected an external power source (such as the external power source 211 in FIG. 2). At operation 605, responsive to determining that the aircraft is connected to the external power source, one or more processes (such as the SRDCS 205) executing on the LRU 207 or other computer-based processing device switches a wireless interface of the aircraft (such as the wireless interface 213) to a receive-only mode. By eliminating the possibility of the test interface 217 transmitting through the aircraft’s wireless interface, the possibility of the test interface sending interfering signals is also eliminated.

At operation 610, the aircraft-based processing device receives, via the wireless interface at a first time, a first beacon packet (such as the first beacon packet 251), which contains first encrypted authentication information. The beacon packet can have the frame structure 400 described with reference to FIG. 4, where the first encrypted authentication information is provided as part of vendor-specific information (such as vendor-specific information 411) having an expected sequence length and location within the first beacon packet. At operation 615, the aircraft-based processing device can receive, at a second time subsequent to the first time, a second beacon packet (such as the second beacon packet 253) including second authentication information. The second beacon packet can have a similar frame structure to the first beacon packet, with the second encrypted authentication information being of equivalent length and location within the second beacon packet as the first encrypted authentication information.

At operation 620, the aircraft-based processing device performs a first authentication based on the first and second encrypted authentication information and the timing of the arrival of the second beacon packet relative to the arrival of the first beacon packet. In some embodiments, the first authentication operation can be based on one or more of (i) a comparison of unique device identifier information in the beacon packets, (ii) the sequence number of the second beacon packet relative to the first beacon packet, and (iii) whether the second beacon packet arrived outside of a timeout window (such as the timeout window 255) and within a tolerance window (such as the tolerance window 257) as described with reference to FIGS. 5C and 5D.

At operation 625, responsive to a successful first authentication, the aircraft-based processing device switches the test interface 217 to an enabled mode (such as is described with reference to operation 547). At operation 630, the aircraft-based processing device also performs a second authentication (such as a WPA/DTLS authentication as described in FIGS. 5E and 5F) between the test interface 217 and the device sending the first and second beacon packets (such as the test computer 209). At operation 630, based on successfully performing the second authentication, a secure two-way wireless communication connection between the test interface 217 and the device sending the first and second beacon packets is established. Additionally, at operation 630 first response packets are sent via the secure two-way wireless connection from the test interface 217 to the source of the first and second beacon packets (such as is described with reference to operation 575).

Note that the operations described with reference to FIG. 6 are intended to be illustrative, rather than limitative of, embodiments according to this disclosure. While the operations of the method 600 have been described with reference to processing devices that wireless communicate using Wi-Fi protocols and Wi-Fi based security structures, this disclosure is not limited thereto. Embodiments in which the operations of the method 600 are carried out by devices connected using different wireless communication protocols (such as 5G or BLUETOOTH) are possible and within the scope of this disclosure.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine-readable medium excludes wired, wireless, optical, or other communication links that transport transitory electrical or other signals. A non-transitory computer or machine-readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described some embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
determining whether an aircraft is connected to an external power source, wherein flight control software of the aircraft is configured to provide a test interface;
responsive to determining that the aircraft is connected to the external power source, switching a wireless interface of the aircraft to a receive-only mode;
receiving, via the wireless interface at a first time, a first beacon packet containing first encrypted authentication information;
receiving, via the wireless interface at a second time, a second beacon packet containing second encrypted authentication information;
performing a first authentication based on the first and second encrypted authentication information and arrival of the second beacon packet in a predetermined time window;
responsive to performing the first authentication successfully, switching the test interface to an enabled mode and performing a second authentication between the test interface and a source of the first and second beacon packets; and
responsive to performing the second authentication successfully, establishing a secure two-way wireless communication connection between the test interface and the source of the first and second beacon packets and transmitting, via the secure two-way wireless communication connection, first response packets from the test interface.

2. The method of claim 1, wherein the first encrypted authentication information comprises an integrity check value (ICV) and data encrypted with a pre-shared symmetric key.

3. The method of claim 2, wherein the data encrypted with the pre-shared symmetric key comprises at least one of: a unique identifier, a sequence number of the first beacon packet, and a timeout timer value.

4. The method of claim 3, wherein the predetermined time window comprises a tolerance window subsequent to a timeout window, the timeout window having a length based on the timeout timer value.

5. The method of claim 1, wherein the second authentication comprises at least one of: an authentication according to a Wi-Fi Protected Access (WPA) protocol and an authentication according to a Datagram Transport Layer Security (DTLS) protocol.

6. The method of claim 1, wherein the at least one processing device forms part of an avionics line replaceable unit (LRU).

7. The method of claim 1, further comprising, prior to sending second response packets from the test interface, at least one of:
determining whether the aircraft is still connected to the external power source;
determining whether the test interface is in the enabled mode; or
determining whether the secure two-way wireless communication connection between the test interface and the source of the first and second beacon packets has timed out.

8. An apparatus comprising:
a wireless interface; and
at least one processing device configured to:
determine whether an aircraft is connected to an external power source;
responsive to determining that the aircraft is connected to the external power source, switch the wireless interface to a receive-only mode;
receive, via the wireless interface at a first time, a first beacon packet containing first encrypted authentication information;
receive, via the wireless interface at a second time, a second beacon packet containing second encrypted authentication information;
perform a first authentication based on the first and second encrypted authentication information and arrival of the second beacon packet in a predetermined time window;
responsive to performing the first authentication successfully, switch a test interface of flight control software of the aircraft to an enabled mode and perform a second authentication between the test interface and a source of the first and second beacon packets;
responsive to performing the second authentication successfully, establish a secure two-way wireless communication connection between the test interface and the source of the first and second beacon packets and transmit, via the secure two-way wireless communication connection, first response packets from the test interface.

9. The apparatus of claim 8, wherein the first encrypted authentication information comprises an integrity check value (ICV) and data encrypted with a pre-shared symmetric key.

10. The apparatus of claim 9, wherein the data encrypted with the pre-shared symmetric key comprises at least one of: a unique identifier, a sequence number of the first beacon packet, and a timeout timer value.

11. The apparatus of claim 10, wherein the predetermined time window comprises a tolerance window subsequent to a timeout window, the timeout window having a length based on the timeout timer value.

12. The apparatus of claim 8, wherein the second authentication comprises at least one of: an authentication according to a Wi-Fi Protected Access (WPA) protocol and an authentication according to a Datagram Transport Layer Security (DTLS) protocol.

13. The apparatus of claim 8, wherein the apparatus is an avionics line replaceable unit (LRU).

14. The apparatus of claim 8, wherein the at least one processing device is further configured, prior to sending second response packets from the test interface, to at least one of:
determine whether the aircraft is still connected to the external power source;
determine whether the test interface is in the enabled mode; or
determine whether the secure two-way wireless communication connection between the test interface and the source of the first and second beacon packets has timed out.

15. A non-transitory machine-readable medium containing instructions that when executed cause at least one processor to:
determine whether an aircraft is connected to an external power source;
responsive to determining that the aircraft is connected to the external power source, switch a wireless interface to a receive-only mode;
receive, via the wireless interface at a first time, a first beacon packet containing first encrypted authentication information;
receive, via the wireless interface at a second time, a second beacon packet containing second encrypted authentication information;
perform a first authentication based on the first and second encrypted authentication information and arrival of the second beacon packet in a predetermined time window;
responsive to performing the first authentication successfully, switch a test interface of flight control software of the aircraft to an enabled mode and perform a second authentication between the test interface and a source of the first and second beacon packets;
responsive to performing the second authentication successfully, establish a secure two-way wireless communication connection between the test interface and the source of the first and second beacon packets and transmit, via the secure two-way wireless communication connection, first response packets from the test interface.

16. The non-transitory machine-readable medium of claim 15, wherein the first encrypted authentication information comprises an integrity check value (ICV) and data encrypted with a pre-shared symmetric key.

17. The non-transitory machine-readable medium of claim 16, wherein the data encrypted with the pre-shared symmetric key comprises at least one of: a unique identifier, a sequence number of the first beacon packet, and a timeout timer value.

18. The non-transitory machine-readable medium of claim 17, wherein the predetermined time window comprises a tolerance window subsequent to a timeout window, the timeout window having a length based on the timeout timer value.

19. The non-transitory machine-readable medium of claim 15, wherein the second authentication comprises at least one of: an authentication according to a Wi-Fi Protected Access (WPA) protocol and an authentication according to a Datagram Transport Layer Security (DTLS) protocol.

20. The non-transitory machine-readable medium of claim 15, further containing instructions that when executed cause the at least one processor, prior to sending second response packets from the test interface, to at least one of:
determine whether the aircraft is still connected to the external power source;
determine whether the test interface is in the enabled mode; or
determine whether the secure two-way wireless communication connection between the test interface and the source of the first and second beacon packets has timed out.
